(19) United States
(12) Patent Application Publication
(10) Pub. No.: US 2019/0122270 A1
(43) Pub. Date: Apr. 25, 2019

(54) TECHNIQUES FOR GENERATING NEW PRICING ALGORITHMS FOR PRODUCTS AND SERVICES

(71) Applicant: WAL-MART STORES, INC., Bentonville, AR (US)

(72) Inventors: Matyas Attila Sustik, San Francisco, CA (US); Brian Thomas Seaman, San Francisco, CA (US)

(73) Assignee: WAL-MART STORES, INC., Bentonville, AR (US)

(21) Appl. No.: 15/788,344

(22) Filed: Oct. 19, 2017

(51) Int. Cl. G06Q 30/02; G06F 3/0484

(52) U.S. Cl. CPC G06Q 30/0283; G06F 17/11; G06F 3/04847

(57) ABSTRACT

The present disclosure relates to techniques for combining stored pricing algorithms to generate new pricing algorithms. A control panel interface includes selectable options associated with a plurality of pricing algorithms and a plurality of combination techniques. Selections are received that identify at least two pricing algorithms and at least one combination technique. A new pricing algorithm is generated based on the selections. The new pricing algorithm is configured to compute prices for products and services by executing the selected pricing algorithms to generate a set of price outputs, and executing the selected combination technique to compute a price based on the set of price outputs generated by the pricing algorithms.

### TECHNICAL FIELD

This disclosure relates generally to pricing techniques and, more particularly, to pricing techniques which combine outputs from a plurality of pricing algorithms to generate new pricing algorithms for products and services.

### BACKGROUND

Pricing algorithms are utilized to set prices for products or services being offered by sale. The particular pricing algorithm that is selected for pricing a product or service can vary based upon an objective or goal sought to be achieved (e.g., to maximize profits or to increase market share) by a business. Failing to properly price a product or service can negatively impact the business' efforts to achieve the objective and, in some cases, can even affect the survival of the business.

Because pricing decisions play such an important role, businesses often spend significant resources in developing appropriate pricing algorithms. However, current techniques for developing pricing algorithms are inefficient, time-consuming and resource-intensive. Moreover, the development of the pricing algorithms extends amount of time required to bring a product or service to market. These drawbacks are often attributable to the fact that the development of the pricing algorithms involves defining and solving optimization problems, which can be tedious and laborious tasks.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 6;

FIG. 2 illustrates a representative block diagram of an example of the elements included in the circuit boards inside a chassis of the computer system of FIG. 1;

FIG. 3 illustrates a representative block diagram of a system according to certain embodiments;

FIG. 4 illustrates an exemplary control panel interface according to certain embodiments;

FIG. 5 is a flowchart for a method according to certain embodiments; and

FIG. 6 illustrates a representative block diagram of a portion of the system of FIG. 3 according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXEMPLARY EMBODIMENTS

A number of embodiments can include a system. The system can include one or more processing modules and one or more non-transitory storage modules storing computing instructions configured to run on the one or more processing modules. The one or more storage modules can be configured to run on the one or more processing modules and perform the act of generating instructions for displaying a control panel interface that includes selectable options associated with a plurality of pricing algorithms and a plurality of combination techniques; receiving a first set of selections via the control panel interface that identify at least two pricing algorithms from the plurality of pricing algorithms; receiving a second set of selections via the control panel interface that identify at least one combination technique from the plurality of combination techniques; generating a price for the product or service by: executing each of the at least two pricing algorithms to generate a set of price outputs; and afterwards, executing the at least one combination technique to compute the price for the product or service, wherein the at least one combination technique utilizes the set of price outputs.

Various embodiments include a method. The method can include: generating instructions for displaying, on a display device, a control panel interface that includes selectable options associated with a plurality of pricing algorithms and a plurality of combination techniques; receiving a first set of selections via the control panel interface that identify at least two pricing algorithms from the plurality of pricing algorithms; receiving a second set of selections via the control panel interface that identify at least one combination technique from the plurality of combination techniques; generating a price for the product or service by: executing each of the at least two pricing algorithms to generate a set of price outputs; and afterwards, executing the at least one combination technique to compute the price for the product or service, wherein the at least one combination technique utilizes the set of price outputs.

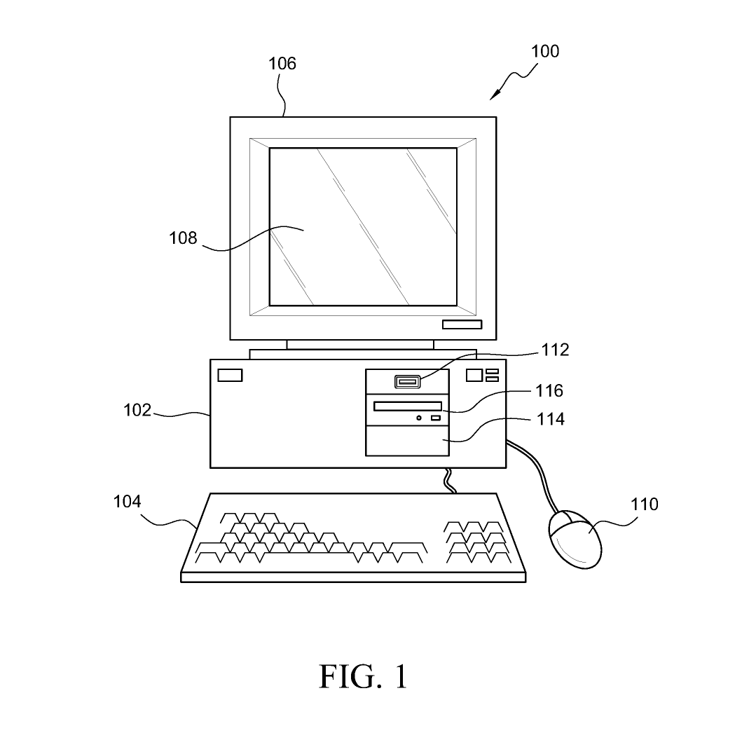

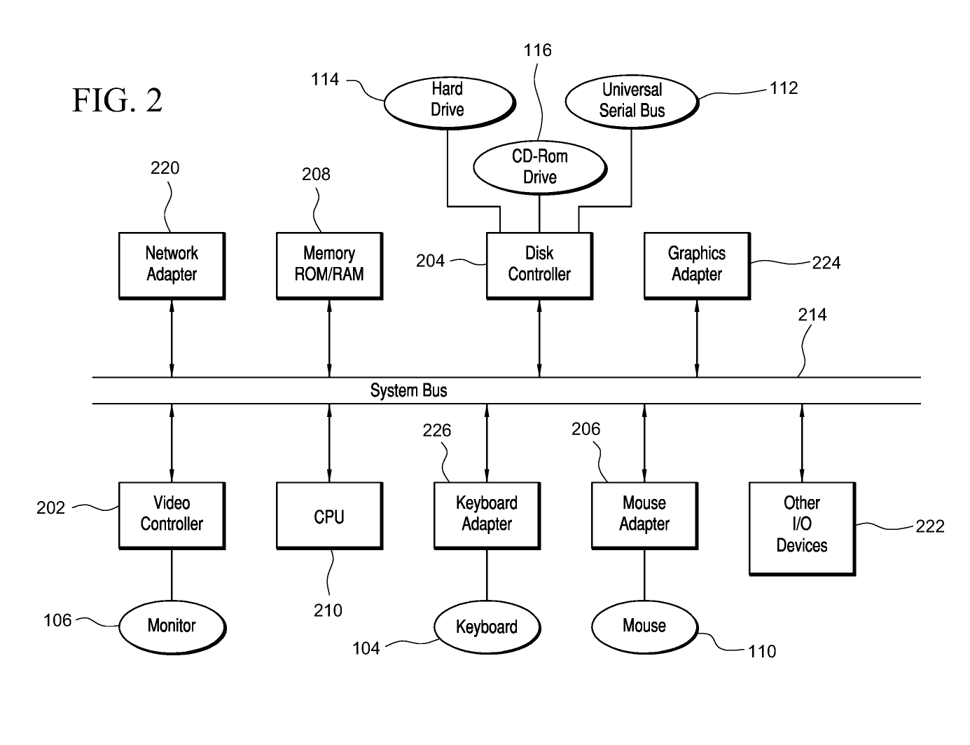

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

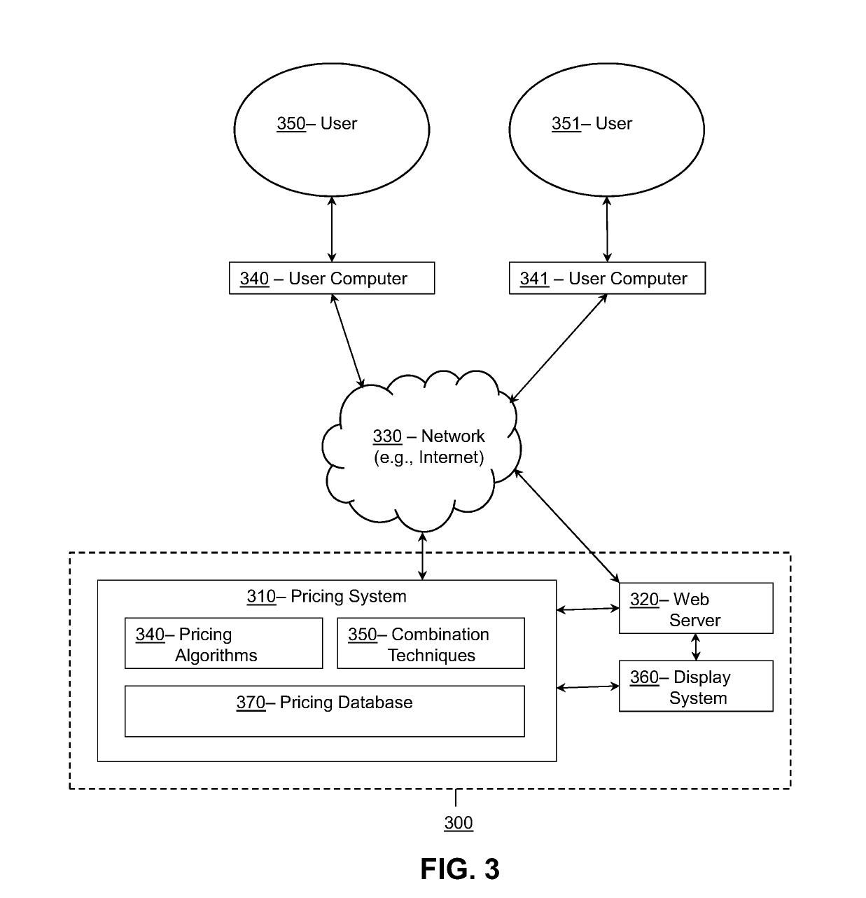

Turning ahead in the drawings, FIG. 3 illustrates a block diagram of a system 300 that can be employed to generate or determine prices and related information for products and services. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a pricing system 310, a web server 320, pricing algorithms 340, combination techniques 350, a display system 360 and/or a pricing database 370. Pricing system 310, web server 320 and display system 360 can each be a computer system, such as computer system 100 (FIG. 1), as described above, and can each be a single computer, a single server, or a cluster or collection of computers or servers, or a cloud of computers or servers. In another embodiment, a single computer system can host each of two or more of a pricing system 310, a web server 320, pricing algorithms 340, combination techniques 350, a display system 360 and/or a pricing database 370. Additional details regarding the pricing system 310, a web server 320, pricing algorithms 340, combination techniques 350, a display system 360 and/or a pricing database 370 are described herein.

In many embodiments, system 300 also can comprise user computers 340, 341. In some embodiments, user computers 340, 341 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through a network 330 with user computers (e.g., 340, 341). The network may be any type of network such as one that includes the Internet, a local area network, a wide area network, an intranet, an extranet, and/or other network. In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, pricing system 310, web server 320, and display system 360 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) (e.g., pricing system 310, web server 320, pricing algorithms 340, combination techniques 350, display system 360 and/or pricing database 370) in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of pricing system 310, web server 320, and display system 360. In a similar manner, the processing module(s) and the memory storage module(s) can be local and/or remote to each other.

In many embodiments, the pricing system 310, web server 320, pricing algorithms 340, combination techniques 350, display system 360 and/or pricing database 370 can be configured to communicate with one or more user computers 340 and 341. In some embodiments, user computers 340 and 341 also can be referred to as customer computers. In some embodiments, the pricing system 310, web server 320, pricing algorithms 340, combination techniques 350, display system 360 and/or pricing database 370 can communicate or interface (e.g., interact) with one or more customer computers (such as user computers 340 and 341) through a network 300, e.g., the Internet. The network 330 can be an intranet that is not open to the public. Accordingly, in certain embodiments, the pricing system 310, web server 320, pricing algorithms 340, combination techniques 350, display system 360 and/or pricing database 370 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case, user computers 340 and 341 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, the pricing system 310, web server 320, pricing algorithms 340, combination techniques 350, display system 360 and/or pricing database 370 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between the pricing system 310, web server 320, pricing algorithms 340, combination techniques 350, display system 360 and pricing database 370, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

Businesses may select specific pricing strategies to achieve certain objectives. For example, in some cases, prices may be set to maximize profitability for each unit sold or from the overall market. In other cases, prices may be set to defend a business' existing market share from new entrants, to increase market share, or to enter a new market. The success of the business in achieving their objective is largely tied to the prices which are assigned to the products and/or services offered by the business.

In view of the foregoing, businesses spend large amounts of money, time and resources to develop appropriate pricing algorithms that can be used to price products and/or services. However, the process of determining an appropriate pricing algorithm for a product or service is no easy task. As mentioned above, this process, which often involves solving optimization problems that account for specific factors or variables that will affect the pricing of the product or service, can be time-consuming and resource-intensive for the businesses.

As discussed throughout this disclosure, the pricing system 310 is configured to determine an optimal price for a product or service in a quick and efficient manner and without requiring a business or individual to spend resources solving optimization problems or other time-consuming tasks. In certain embodiments, the pricing system 310 is configured to generate an interface that includes a control panel that assists users with creating customized pricing algorithms 340, which can be utilized to generate prices for the products and services. The pricing system 310 includes a plurality of pre-store or pre-determined pricing algorithms 340 and a plurality of combination techniques 350. The control panel interface includes selectable input elements (e.g., checkboxes and/or radio buttons) that correspond to the stored pricing algorithms 340 and the stored combination techniques 350. Specifically, a user can select the input elements associated with the pricing algorithms 340 and combination techniques 350 to create and define new pricing algorithms that are customized to achieve specific business objectives.

In response to a user selecting two or more of the pricing algorithms 340 and a combination technique 350, the pricing system 310 will execute the selected pricing algorithms 340 to generate outputs. Next, the selected combination technique 350 is executed to combine the outputs of the selected pricing algorithms 340 in various manners. In this manner, the pricing system 310 enables users to test and experiment with different pricing strategies by selecting different options on the control panel interface. This permits the users to quickly and efficiently generate an optimal pricing algorithm 340 for a product or service without having to solve a new optimization problem.

The pricing algorithms 340 can include any currently known or later-developed pricing algorithms or pricing techniques. Exemplary pricing algorithms 340 can be based on any of the following pricing models or techniques: absorption pricing, loss leader, marginal-cost, contribution margin-based, cost plus, value-based pricing, time-based pricing, variability pricing, yield management, creaming or skimming, decoy pricing, freemium, high-low pricing, creaming or skimming, keystone, limit pricing, odd pricing, pay what you want, penetration, predatory, premium decoy, price discrimination, price leadership, psychological pricing, target pricing, and/or any other pricing model or technique. The pricing algorithms 340 also can include customized pricing algorithms (e.g., algorithms that are customized for a specific objective or marketplace solution).

Regardless of which pricing algorithms 340 are stored on the price system 310, each of the pricing algorithms 340 may be configured to receive, retrieve and/or access inputs stored in a pricing database 370 for computing or generating a price for the products or services. The pricing inputs utilized by each of the pricing algorithms 340 may vary. Generally speaking, the pricing inputs may include any data that can be useful to pricing products and/or services. Exemplary pricing inputs utilized by the pricing algorithms 340 to compute prices may include some or all of the following: product or service costs (e.g., material, overhead and labor costs), inventory levels, competitor prices, target profits, manufacturer suggested retail prices (MSRPs), minimum floor and ceiling prices, wholesale prices, market share ownership, etc. Other types of pricing inputs also may be utilized by the pricing algorithms 340.

The stored combination techniques 350 may generally include any function or technique that is configured to receive a set of pricing outputs and utilize the set of outputs to generate prices for products and services. Exemplary combination techniques 350 may include functions that combine, or operate on, the outputs using techniques that are based on one or more of the following: convex combinations, weighting values, mode values, median values and/or arithmetic average values. Other types of combination techniques 350 also may be used. Regardless of which combination techniques 350 is selected, the selected combination technique 350 computes or outputs a suggested price based on a set of prices (e.g., based on a set of pricing outputs generated by the selected pricing algorithms 340).

Below is an example of a combination technique 350 that utilizes a convex combination function to combine the outputs of two pricing algorithms 340:

p_new=p_1*alpha+p_2*(1−alpha)

where:

alpha is a user selected value such that 0<=alpha<=1;

p_1 is a price output generated by a first pricing algorithm;

p_2 is a price output generated by a second pricing algorithm; and

p_new is a suggested price computed for a product or service.

It should be recognized that the above combination technique 350, which is based on a convex combination, can be modified accordingly to receive and combine outputs from more than two pricing algorithms.

Below is an example of a combination technique 350 that utilizes a median function to combine the outputs of two pricing algorithms 340:

p_new=median(p_1, p_2, . . . , p_n)

where:

p_1, p_2, . . . , p_n are price outputs generated by pricing algorithms 1-n;

n is an index identifying for the price outputs;

median( ) is a function that selects a median value from the price inputs; and

p_new is the price computed for a product or service.

In certain embodiments, before the above median-based combination technique 350 is executed, the prices p_1, p_2, . . . , p_n are analyzed to identify and remove outlier values.

In certain embodiments, the control panel interface enables a user to select more than one combination technique 350 to generate a new pricing algorithm that can be utilized to price products and services. The control panel interface may include a tool or input form which enables a user to specify how each of the selected combination techniques 350 are to be applied to the outputs of the selected pricing algorithms 340. Generally speaking, the tool or input form included on control panel interface can be configured to permit the user to apply the combination techniques 350 in a variety of different ways.

To illustrate this feature further, consider an exemplary situation in which a user has selected four pricing algorithms 340 (i.e., PA1, PA2, PA3 and PA4) and two combination techniques 350 (i.e., CT1 and CT2) to be utilized in generating a new pricing algorithm 340. After selecting the pricing algorithms 340 and combination techniques 350, the control panel interface may prompt or enable a user to specify how the selected combination techniques 350 are to be combined. For example, a user may specify that a first combination technique (CT1), which provides a median-based combination method, is to select a median value from outputs of three pricing algorithms (PA1, PA2 and PA3). The user may further specify that the second combination method (CT2), which provides an average or mean-based operation on a set of values, is to be applied to the output produced by the first combination technique (i.e., the median value selected by CT1) and the output of the fourth selected pricing algorithm (CT4). The output of the second combination method (CT2) may then represent a suggested price that can be utilized to price the subject product or service. As demonstrated by the example above, the control panel interface enables a user to specify that the combination techniques 350 can be applied in a tiered or nested manner.

As another example, a user may utilize the control panel interface to specify that a first combination technique 350 (CT1) is to perform a combination operation on outputs from a first set of pricing algorithms 340 (PA1-PA5) and a second combination technique 350 (CT2) is to perform a combination operation on outputs from a second set of pricing algorithms 340 (PA3-PA7). In this example, there is some overlap between the sets which are provided as inputs to the first and second combination techniques 350, such that the outputs of PA3-PA5 are included in both sets. The user may further specify that a third combination technique 350 (CT3) is to receive the outputs of the first and second combination techniques 350 (CT1 and CT2) and to perform a combination operation which uses the outputs of the first and second combination techniques 350 as inputs to a third combination technique 350 (CT3). The output of the third combination technique 350 (CT3) may then represent a price than can be utilized to price a product or service.

It should be evident from the discussion provided above that multiple combination techniques 350 can be applied to generate prices for products and services in other ways as well. Generally speaking, the control panel interface can be configured to permit the user to apply the combination techniques 350 in any manner possible.

In certain embodiments, the control panel interface further includes input elements (e.g., input forms or selectable options) that enable users to customize parameters associated with the selected combination techniques 350. Generally speaking, the control panel interface can be configured to permit the user to customize any and all parameters associated with combination techniques 350. For example, in the example discussed above relating to the combination technique 350 which utilizes a convex combination, the alpha value may be a value that is specified by the user via the control panel interface. Similarly, in the event that a combination technique 350 is selected that utilizes a mean, mode or median function, the control panel interface may provide the user with a parameter which enables the user to determine how outlier values should be removed. As another example, in the event that a combination technique 350 is selected that utilizes weighting values, the control panel interface may provide an input form that enables the user to provide weights for each of the selected pricing algorithms 340.

In certain embodiments, the control panel interface further includes selectable input elements that correspond to objectives that may be selected by the user. Exemplary objectives may include maximizing profit, defending a market share, increasing a market share, entering a new market, business survival, increasing sales volume or quantity, company growth, maximizing long-run profit, maximizing short-run profit, obtaining a target rate of return on investment (ROI), desensitizing customers to price, obtaining a target rate of return on sales, stabilizing a market, stabilizing a market price, maintaining price leadership, discouraging new entrants to a market or industry, obtaining or maintaining customer loyalty, etc. Selecting an objective displayed on the control panel interface notifies the pricing system 310 of the user's intentions regarding the pricing algorithm that is being developed or tested. The pricing system 310 may utilize this information to recommend pricing strategies, to adjust parameters (e.g., weighting values or the above-described alpha value) associated with the pricing algorithms 340. In certain embodiments, the selected objectives also may be utilized to automatically select particular pricing algorithms 340 to be utilized in pricing a product or service.

In certain embodiments, any prices and/or pricing algorithms generated by the pricing system 310 may be stored in the pricing database 370. In certain embodiments, the prices and/or pricing algorithms generated by the pricing system 310 may be transmitted over the network 330 to a server (e.g., a server associated with an e-commerce site which offers the products and/or services with the generated prices) and/or one or more user computers 340, 341 (e.g., user computers who access an e-commerce site in order to purchase the products and/or services at the prices generated by the pricing system 310).

In certain embodiments, the pricing algorithms 340 generated by the pricing system 310 may be incorporated into an e-commerce site to dynamically compute and update prices for products and/or services offered for sale on the site. For example, a web server 320 or other component of the pricing system 310 may dynamically utilize one or more pricing algorithms developed by the pricing system 110 to dynamically update prices (e.g., which may be stored in the pricing database 370) for products and services as pricing inputs change over time (e.g., as inventory levels, costs or other pricing inputs change over time). Additionally, or alternatively, the one or more pricing algorithms developed by the pricing system 110 can be executed by a user (e.g., an administrator or pricing specialist associated with a business) on a remote computer and then the prices can be transmitted over the network 330 to a server for use by an e-commerce site and/or a database that provides pricing information at retail locations. Additionally, or alternatively, the one or more pricing algorithms developed by the pricing system 110 can be triggered to update prices for products by an event-driven streaming model which updates pricings in response to receiving or detecting certain events (e.g., in response to changing market conditions or changing pricing inputs).

It should be recognized that the pricing system 310 provides a variety of advantages. One important advantage provided by the pricing system 310 is that it enables the quick and efficient development of new pricing algorithms which are customized for particular products and services. This is due, at least in part, to the fact that the pricing system 310 allows businesses to leverage existing pricing algorithms without having to spend the time and resources with developing new pricing algorithms and/or solving new optimization problems. Instead, users can quickly and easily test and generate new pricing algorithms by selecting combinations of pricing algorithms 340 stored on the pricing system 310.

Another important advantage provided by the pricing system 310 relates to the fact that it allows a user to easily develop a new pricing algorithm that achieves and balances multiple, and possibly competing, objectives. For example, a user may wish to develop a pricing strategy with a primary objective of increasing profits per unit of sale and a secondary objective of increasing market share. To accomplish this, a user can simply select pre-stored algorithms 340 that are known to produce useful outputs for achieving the primary and secondary objectives, and then assign a combination operation which specifies how the outputs of the selected algorithms 340 are to be combined (e.g., by possibly selecting a weighted combination technique and specifying a greater weighting value for the primary objective in comparison to the secondary objective). Thus, the price generated by the pricing system 310 can represent a value that strikes a balance among a variety of objectives.

The above advantages of the pricing system 310 are enabled, at least part, by certain technical features and enhancements that are incorporated into the pricing system 310. For example, the novel control panel interface represents improvements over existing graphical user interfaces by providing a set of customizable tools that enables users to combine and customize stored pricing algorithms in an effort to test and develop new pricing algorithms. As described throughout this disclosure, the control panel interface accesses and operates on a set of specific rules (e.g., rules controlling combination techniques, algorithms, and interface layout) to provide this functionality. This unique testing and development platform overcomes the aforementioned problems associated with prior art pricing techniques (e.g. such as those which are resource-intensive and time-consuming, and/or involve solving optimization problems to develop customized pricing algorithms).

Additionally, in certain embodiments, other technical features can be found in scenarios where the pricing algorithms 340 generated by the pricing system are utilized to dynamically update prices for products and/or services that are offered for sale on an e-commerce site. In cases where an e-commerce site provides a large offering of products and/or services (e.g., for hundreds or thousands of products and/or services) and updates to prices are required frequently due to underlying changes in the pricing input information (e.g., changes in inventory levels), it would not be possible for a human to manually detect and/or implement the necessary changes in a timely fashion. Thus, integrating the pricing algorithms 340 developed by the pricing system 110 into the e-commerce platform to dynamically process these updates in real-time overcomes these limitations.

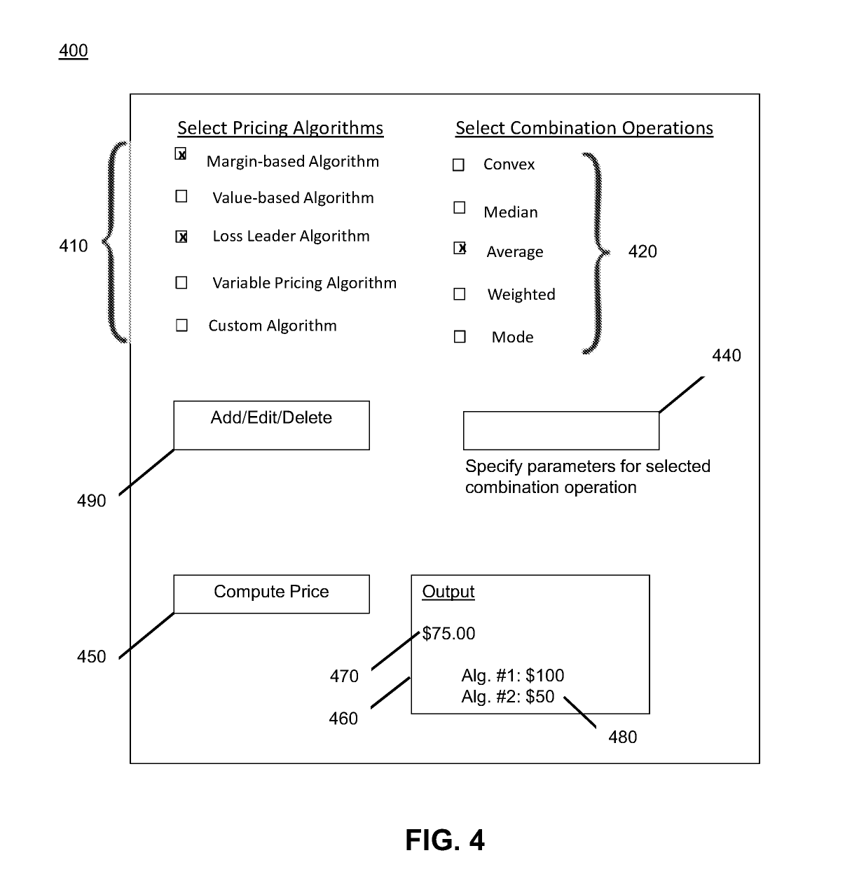

FIG. 4 illustrates an exemplary control panel interface 400 according to certain embodiments. The control panel interface 400 includes an algorithm selection section 410, a combination technique selection section 420, a parameter section 440, a compute button 450, an administration feature 490, and an output section 460.

The algorithm selection section 410 provides a listing of pricing algorithms 340 (FIG. 3). While five exemplary pricing algorithms 340 (FIG. 3) are listed on the exemplary interface in FIG. 4, it should be recognized that any number of pricing algorithms 340 may be displayed and that other types of pricing algorithms 340 can be included in the listing. Selectable input elements (e.g., checkboxes) are located next to each of the listed pricing algorithms 340 (FIG. 3). A user may select (e.g., with a mouse device or using a gesture on a touch screen) the pricing algorithms 340 (FIG. 3) to be utilized in generating prices for products and services.

The combination technique selection section 420 provides a listing of combination techniques 350 (FIG. 3). Once again, while there are five exemplary combination techniques 350 (FIG. 3) listed on the interface, it should be recognized that any number of combination techniques 350 (FIG. 3) may be displayed and that other types of combination techniques 350 (FIG. 3) can be included in the listing. Selectable input elements (e.g., checkboxes) are located next to each of the listed combination techniques 350. A user may select the combination techniques 350 (FIG. 3) to be utilized in generating prices for products and services.

The parameter section 440 includes an input form (e.g., which may include one or more text boxes, one or more sliding scales, one or more check boxes, and/or one or more radio buttons) that enables the user to specify parameters or values that can be utilized to customize the selected combination techniques 350 (FIG. 3). Generally speaking, the parameter section 440 can be used to specify any parameters associated with the combination techniques 350 (FIG. 3) that are selected. For example, in the event that a combination technique 350 (FIG. 3) is selected which weights the outputs of the selected pricing algorithms 340 (FIG. 3), the parameter section 440 may permit the user to specify weight values that are to be assigned to the various outputs of the selected pricing algorithms 340 (FIG. 3). As another example, the parameter section 440 may permit the user to specify variables (e.g., the aforementioned alpha values) to be utilized in connection with convex combination techniques. Also, in the event a user selects more than one combination technique 350 (FIG. 3), the parameter section 440 can allow the user to specify how the selected combination techniques 350 (FIG. 3) are applied to generate the prices (e.g., as described above with respect to specifying the tiered or nested structuring of the combination techniques 350 (FIG. 3)).

After a user has selected two or more of the pricing algorithms 340 (FIG. 3) and at least one combination technique 350 (FIG. 3) (and, if applicable, any information in the parameter section 440), the user may select the compute button 450. In response to selecting the compute button 450, the pricing system 310 (FIG. 3) may retrieve pricing input information from a pricing database 370 (FIG. 3), execute each of the selected pricing algorithms 340 (FIG. 3) using the retrieved pricing input information, execute the selected combination technique(s) using the outputs of the pricing algorithms 340 (FIG. 3), and display a calculated price 470 in the output section 460. In certain embodiments, in addition to displaying the calculated price 470, the output section 460 may further display the pricing outputs 480 generated by each of the selected pricing algorithms 340 (FIG. 3) prior to being processed by the selected combination technique 350 (FIG. 3).

The control panel interface 400 further includes an admin feature 490 that enables pricing algorithms 340 (FIG. 3) and combination techniques 350 (FIG. 3) to be added to the interface 400, removed from the interface 400 and/or edited or modified. For example, after a user selects one or more of the pricing algorithms 340 (FIG. 3) and/or one or more of the combination techniques 350 (FIG. 3), the user may utilize the admin feature 490 to modify or delete the selected pricing algorithms 340 (FIG. 3) and combination techniques 350 (FIG. 3). Along similar lines, the user may select the admin feature 490 to define or input new pricing algorithms 340 (FIG. 3) and combination techniques 350 (FIG. 3).

The control panel interface 400 illustrated in FIG. 4 is intended to be exemplary and not limiting. It should be recognized that various modifications can be made to the control panel interface 400. For example, in certain embodiments, the interface 400 can include an objective selection section that provides a listing of objectives. Selectable input elements (e.g., checkboxes) may located next to each of the listed objectives, and a user may select one or more of the objectives to be utilized in generating prices for products and services. In response to selecting an objective, the pricing system 310 (FIG. 3) may automatically select or recommend pricing algorithms 340 (FIG. 3) to be utilized, and/or may automatically adjust or recommend adjustments to the parameters being utilized by the combination techniques 350 (FIG. 3) (e.g., to the values included in the parameter section 440). Other types of modifications and/or additions may be made to the control panel interface 400.

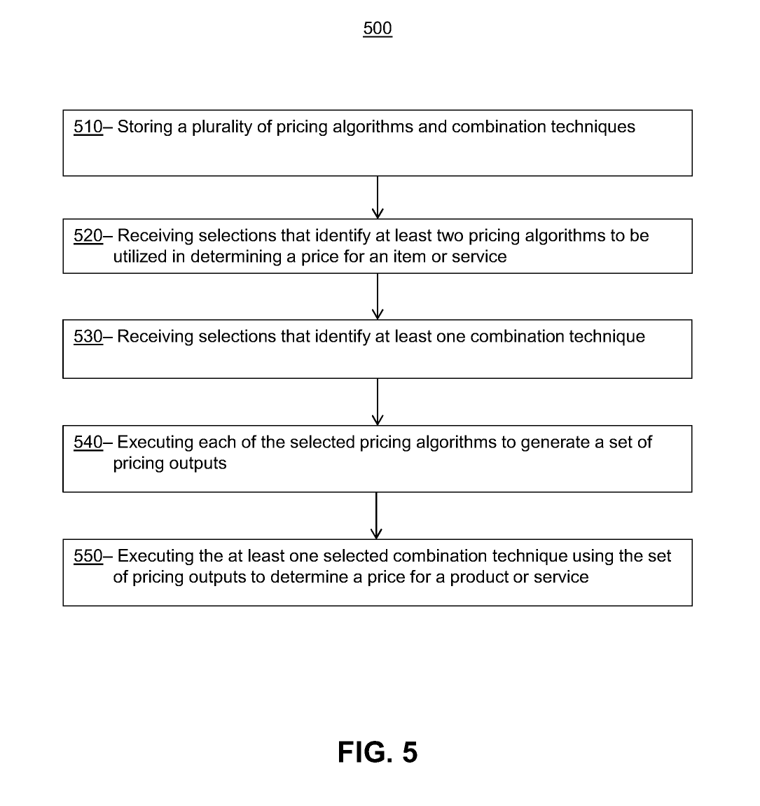

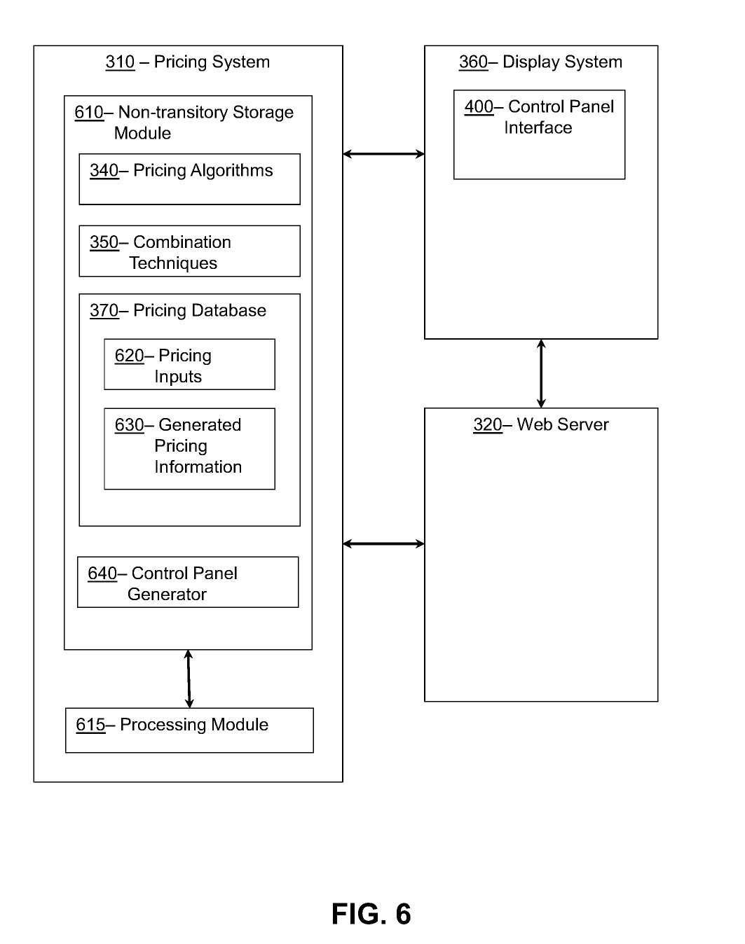

Turning ahead in the drawings, FIG. 5 illustrates a flow chart for a method 500 according to certain embodiments. Method 500 is merely exemplary and is not limited to the embodiments presented herein. Method 500 can be employed in many different embodiments or examples not specifically depicted or described herein. In certain embodiments, the activities of method 500 can be performed in the order presented. In other embodiments, the activities of method 500 can be performed in any suitable order. In still other embodiments, one or more of the activities of method 500 can be combined or skipped. In many embodiments, system 300 (FIG. 3) can be suitable to perform method 500 and/or one or more of the activities of method 500. In these or other embodiments, one or more of the activities of method 500 can be implemented as one or more computer instructions configured to run at one or more processing modules and configured to be stored at one or more non-transitory memory storage modules 610 (FIG. 6). Such non-transitory memory storage modules can be part of a computer system such as pricing system 310 (FIGS. 3 & 6). The processing module(s) can be similar or identical to the processing module(s) described above with respect to computer system 100 (FIG. 1).

Method 500 can comprise an activity 510 of storing a plurality of pricing algorithms 340 (FIG. 3) and a plurality of combination techniques 350 (FIG. 3). The pricing algorithms 340 (FIG. 3) and combination techniques 350 (FIG. 3) can be stored on a non-transitory memory storage module (e.g., such as 610 in FIG. 6). As explained above, any type of pricing algorithm 340 (FIG. 3) can be stored on the storage medium (e.g., including those which are based on absorption pricing, loss leader, marginal-cost, contribution margin-based, cost plus, etc.). Likewise, any type of combination technique 350 (FIG. 3) can be stored on the storage medium (e.g., including those which are based on convex combinations, averages, medians, modes, etc.).

Method 500 can further comprise an activity 520 of receiving selections that identify at least two pricing algorithms 340 (FIG. 3) to be utilized in determining a price for an item or service. The selections may be received via a GUI that comprises a control panel interface that provides a listing of pricing algorithms 340 (FIG. 3). The selected pricing algorithms 340 (FIG. 3) can be selected based on an objective, or a plurality of objectives, desired by the user operating the control panel interface 400.

Method 500 can further comprise an activity 530 of receiving selections that identify at least one combination technique 350 (FIG. 3). Once again, the selections may be received via a GUI that comprises a control panel interface that provides a listing of combination techniques 350 (FIG. 3). This activity may further comprise receiving information (e.g., via a parameter section 440 of the control panel interface 400) for customizing parameters associated with the at least one combination technique 350 (FIG. 3).

Method 500 can further comprise an activity 540 of executing each of the selected pricing algorithms 340 (FIG. 3) to generate a set of pricing outputs. Each of the selected pricing algorithms 340 (FIG. 3) may utilize pricing inputs stored in a pricing database 370 (FIG. 3) to generate and output a price (or range of prices) for a product or service. The prices generated using the selected pricing algorithms 340 (FIG. 3) can then be stored on a non-transitory memory storage module (e.g., such as 610 in FIG. 6).

Method 500 can further comprise an activity 550 of executing the at least one selected combination technique 350 (FIG. 3) using the set of pricing outputs to determine a price 470 (FIG. 4) for a product or service. The price 470 (FIG. 4) generated using the combination technique 350 (FIG. 3) may be stored on a non-transitory memory storage module (e.g., such as 610 in FIG. 6) and/or transmitted to a server for use in pricing products and/or services that are offered for sale on an e-commerce site and/or retail location.

FIG. 6 illustrates a block diagram of a portion of system 300 (FIG. 3) comprising pricing system 310, web server 320, and display system 360, according to the embodiment shown in FIG. 3. Each of pricing system 310, web server 320, and/or display system 360, is merely exemplary and not limited to the embodiments presented herein. Each of pricing system 310, web server 320, and/or display system 360, can be employed in many different embodiments or examples not specifically depicted or described herein. In some embodiments, certain elements or modules of parameter optimization system 310, web server 320, and/or display system 360, can perform various procedures, processes, and/or acts. In other embodiments, the procedures, processes, and/or acts can be performed by other suitable elements or modules.

The pricing system 310 comprises at least one non-transitory memory storage module 610 and at least one processing module 615 (e.g., which may include one or more CPUs). The at least one non-transitory memory storage module 610 stores pricing algorithms 340, combination techniques 350, a pricing database 370 and a control panel generator 640. The pricing database 370 stores, inter alia, pricing inputs 620 and generated pricing information 630. The pricing inputs 620 can generally include any information that may utilized by the pricing algorithms 340 to produce prices or other outputs. As mentioned above, exemplary pricing inputs 620 may include information relating to costs, margin requirements, current or anticipated inventory levels, target profits, competitor prices, etc. The generated pricing information 630 can generally include any information that is generated by the pricing system 310 and/or the techniques described herein for generating prices for products or services. For example, the generated pricing information 630 may include the prices 470 which are generated by combining outputs of the pricing algorithms 340. The generated pricing information 630 also may include intermediate data that is generated during the process of determining the prices 470 (e.g., the price outputs 480 (FIG. 4) that are individually generated by each of the pricing algorithms 340 before they are processed by the combination techniques 350). The generated pricing information 630 may further include any newly developed pricing algorithms 340 that are developed using the pricing system 310. In this respect, the generated pricing information 630 may include information that identifies a subset of pricing algorithms, a subset of combination techniques 350, and information which explains how the subset of pricing algorithms and the subset of combination techniques are combined to produce a new pricing algorithm 340. Any newly developed pricing algorithm 340 stored in the generated pricing information 630 can be added to the pricing algorithm selection section 410 (FIG. 4) of the control panel interface 400 (FIG. 4) (e.g., using admin feature 490 (FIG. 4)).

The control panel generator 640 can include any instructions associated with providing a control panel interface 400. For example, the control panel generator 640 can include instructions for generating the control panel interface 400 (FIG. 4), rendering the control panel interface 400 (FIG. 4) on the display system 360 (FIG. 3), detecting input events and selections made via the control panel interface 400 (FIG. 4), computing the prices 470 (FIG. 4) and price outputs 480 (FIG. 4) based on the selections made via the control panel interface 400 (FIG. 4), displaying the results of any computations on the control panel interface 400 (FIG. 4) (e.g., via the output section 460 (FIG. 4) of the control panel interface 400 (FIG. 4)), and/or perform any other related activities.

In certain embodiments, the pricing system 310 can store computing instructions configured to run on one or more processing modules and perform one or more acts of method 500 (FIG. 5) (e.g., activities 510, 520, 530, 540, and 550) in connection with combining pricing algorithms 340 to generate prices 470 (FIG. 4) for products and/or service. For example, in certain embodiments, instructions for performing activities 510, 520, 530, 540, and 550 may be stored on non-transitory storage medium 610, and acts 510, 520, 530, 540, and 550 may be performed by the control panel generator 640.

Although systems and methods for generating pricing information have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 5 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
generating instructions for displaying a control panel interface that includes selectable options associated with a plurality of pricing algorithms and a plurality of combination techniques;
receiving a first set of selections via the control panel interface that identify at least two pricing algorithms from the plurality of pricing algorithms;
receiving a second set of selections via the control panel interface that identify at least one combination technique from the plurality of combination techniques; and
generating a price for the product or service by:
executing each of the at least two pricing algorithms to generate a set of price outputs; and
afterwards, executing the at least one combination technique to compute the price for the product or service, wherein the at least one combination technique utilizes the set of price outputs.

2. The system of claim 1, wherein the at least one combination technique utilizes the set of price outputs by receiving the set of price outputs as inputs to a convex function which outputs the price for the product or service.

3. The system of claim 1, wherein the selectable options associated with the plurality of combination techniques include selectable options associated with a convex function, a median function, an arithmetic average function, and a mode function.

4. The system of claim 1, wherein the control panel interface further includes a parameter section that includes an input form that enables parameters associated with the at least one combination technique to be customized.

5. The system of claim 4, wherein the parameter section enables variables associated with the at least one combination technique to be specified by a user.

6. The system of claim 4, wherein:
the at least one combination technique identified by the second set of selections identifies two or more combination techniques; and
the parameter section enables a user to specify how the two or more combination techniques process the set of price outputs to generate the price for the product or service.

7. The system of claim 1, wherein the at least two pricing algorithms generate the set of price outputs based on a plurality of pricing inputs comprising: a margin requirement, inventory information, a target profit, one or more competitor prices, and a manufacturer suggested retail price.

8. The system of claim 1, wherein the control panel interface includes an output section that displays the price and the set of price outputs generated by the at least two pricing algorithms.

9. The system of claim 1, wherein the control panel interface includes:
functions for adding additional pricing algorithms to the plurality of pricing algorithms;
functions for removing pricing algorithms from the plurality of pricing algorithms; and
functions for editing the plurality of pricing algorithms.

10. The system of claim 1, wherein the control panel interface includes:
functions for adding additional combination techniques to the plurality of combination techniques;
functions for removing combination techniques from the plurality of combination techniques; and
functions for editing the plurality of combination techniques.

11. A method comprising:
generating instructions for displaying, on a display device, a control panel interface that includes selectable options associated with a plurality of pricing algorithms and a plurality of combination techniques;
receiving a first set of selections via the control panel interface that identify at least two pricing algorithms from the plurality of pricing algorithms;
receiving a second set of selections via the control panel interface that identify at least one combination technique from the plurality of combination techniques;
generating a price for the product or service by:
executing each of the at least two pricing algorithms to generate a set of price outputs; and
afterwards, executing the at least one combination technique to compute the price for the product or service, wherein the at least one combination technique utilizes the set of price outputs.

12. The method of claim 11, wherein the at least one combination technique utilizes the set of price outputs by receiving the set of price outputs as inputs to a convex function which outputs the price for the price or service.

13. The method of claim 11, wherein the selectable options associated with the plurality of combination techniques include selectable options associated with a convex function, a median function, an arithmetic average function, and a mode function.

14. The method of claim 11, wherein the control panel interface further includes a parameter section that includes an input form that enables parameters associated with the at least one combination technique to be customized.

15. The method of claim 14, wherein the parameter section enables variables associated with the at least one combination technique to be specified by a user.

16. The method of claim 14, wherein:
the at least one combination technique identified by the second set of selections identifies two or more combination techniques; and
the parameter section enables a user to specify how the two or more combination techniques process the set of price outputs to generate the price for the product or service.

17. The method of claim 11, wherein the at least two pricing algorithms generate the set of price outputs based on a plurality of pricing inputs comprising: a margin requirement, inventory information, a target profit, one or more competitor prices, and a manufacturer suggested retail price.

18. The method of claim 11, wherein the control panel interface includes an output section that displays the price and the set of price outputs generated by the at least two pricing algorithms.

19. The method of claim 11, wherein the control panel interface includes:
functions for adding additional pricing algorithms to the plurality of pricing algorithms;
functions for removing pricing algorithms from the plurality of pricing algorithms; and
functions for editing the plurality of pricing algorithms.

20. The method of claim 11, wherein the control panel interface includes:
functions for adding additional combination techniques to the plurality of combination techniques;
functions for removing combination techniques from the plurality of combination techniques; and
functions for editing the plurality of combination techniques.
